(19) United States
(12) Patent Application Publication
(10) Pub. No.: US 2005/0001926 A1
(43) Pub. Date: Jan. 6, 2005

(54) Digital camera capable of emitting light adaptively and method thereof

(75) Inventors: Jin-Gi Lee, Changwon-si (KR); Jae-Chung Lim, Masan-si (KR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 10/837,723

(22) Filed: May 3, 2004

(30) Foreign Application Priority Data
Jul. 3, 2003 (KR) 2003-44856

(51) Int. Cl. H04N 5/222

(52) U.S. Cl. 348/371

(57) ABSTRACT

A digital camera and method is provided that measures an ambient illumination in response to the shutter signal, performs preliminary light emission when the measured ambient illumination is less than a first reference value, delays main light emission by a predetermined time after the preliminary light emission, performs the main light emission after the predetermined time has lapsed, acquires image data during the main light emission, and processes the acquired image data.

### BACKGROUND OF THE INVENTION

This application claims the priority of Korean Patent Application No. 2003-44856, filed on Jul. 3, 2003, in the Korean Intellectual Property Office, the disclosure of which is incorporated herein by reference.

1. Field of the Invention

The present invention relates to a digital camera including a strobe unit and a method for controlling such a digital camera.

2. Description of the Related Art

A conventional strobe unit of a digital camera, for example, a flash light emitting device disclosed in U.S. Pat. No. 6,476,564, does not perform preliminary light emission that would allow a user to adjust image composition in a low-light environment. Because it is difficult for the user to adjust the composition of a subject to be photographed in a low-light environment, the user has difficulties in photographing images.

To overcome this problem, a portable terminal such as a mobile phone including a digital camera may be equipped with an auxiliary lamp such as a light. emitting diode. However, such an auxiliary lamp has a much lower light intensity than a strobe lamp and thus is not helpful in remote photographing in a low-light environment. Moreover, a user needs to manually operate the auxiliary lamp according to his/her determination of the intensity of ambient illumination. Such manual operation is inconvenient and may incur unnecessary operation of the auxiliary lamp.

### SUMMARY OF THE INVENTION

The present invention provides a digital camera and method for emitting light adaptively so that a user can adjust photographic image composition in a low-light environment without needing to perform a special operation.

According to an aspect of the present invention, a digital camera generates a shutter signal when a user presses a shutter button switch. The camera measures an ambient illumination in response to the shutter signal, performing preliminary light emission when the measured ambient illumination is less than a first reference value, delaying main light emission by a predetermined time after the preliminary light emission, performing the main light emission after the predetermined time has lapsed, and acquiring image data during the main light emission and processing the acquired image data.

According to an aspect of the present invention, a method of controlling a digital camera comprises generating a shutter signal when a user presses a shutter button switch. The method comprises measuring an ambient illumination in response to the shutter signal, performing preliminary light emission when the measured ambient illumination is less than a first reference value, delaying main light emission by a predetermined time after the preliminary light emission, performing the main light emission after the predetermined time has lapsed, and acquiring image data during the main light emission and processing the acquired image data.

In the present invention, the preliminary light emission is performed when the ambient illumination measured in response to the shutter signal is less than the first reference value, and then the main light emission is delayed by the predetermined time. Accordingly, under an ambient illumination less than the first reference value, a user can satisfactorily adjust photographic image composition without special operations before the main light emission and the image data acquisition are performed.

### BRIEF DESCRIPTION OF THE DRAWINGS

The above and other features and advantages of the present invention will become more apparent by describing in detail preferred embodiments thereof with reference to the attached drawings in which:

FIG. 1 is a diagram of a digital camera according to the present invention;

FIG. 2 is a flowchart of a photographic mode program performed by a central processing device show in FIG. 1, according to a first embodiment of the present invention;

FIG. 3 is a flowchart of a photographic mode program performed by the central processing device show in FIG. 1, according to a second embodiment of the present invention; and

FIG. 4 is a flowchart of a photographic mode program performed by the central processing device show in FIG. 1, according to a third embodiment of the present invention.

### DETAILED DESCRIPTION OF THE INVENTION

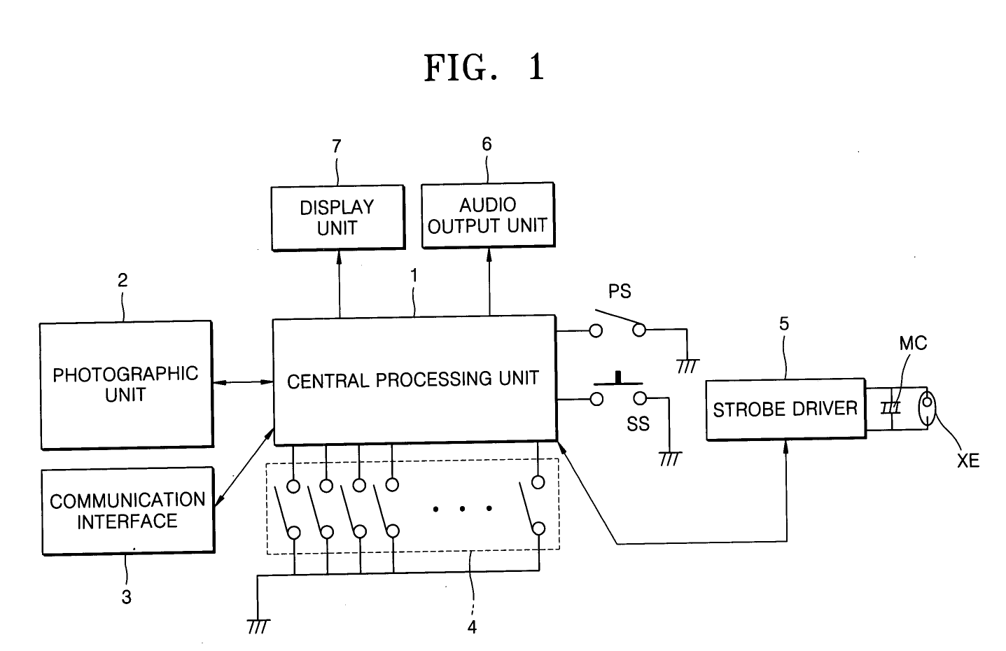

Referring to FIG. 1, a digital camera of the present invention is installed in a portable terminal such as a mobile phone. The digital camera includes a central processing device 1, a photographic unit 2, a communication interface 3, a function selection switch unit 4, a strobe driver 5, an audio output unit 6, a display unit 7, a power switch PS, a shutter button switch SS, a capacitor MC, and a strobe lamp XE.

When a user turns the power switch PS on, the central processing device 1 performs a control algorithm according to an embodiment of the present invention, controls operations of each element, and transmits image data acquired by the photographic unit 2 to external devices via the communication interface 3.

The photographic unit 2 acquires image data and includes lenses, a photoelectric conversion element, and a digital-to-analog converter. The function selection switch unit 4 is manipulated by the user to select an operation of the central processing device 1.

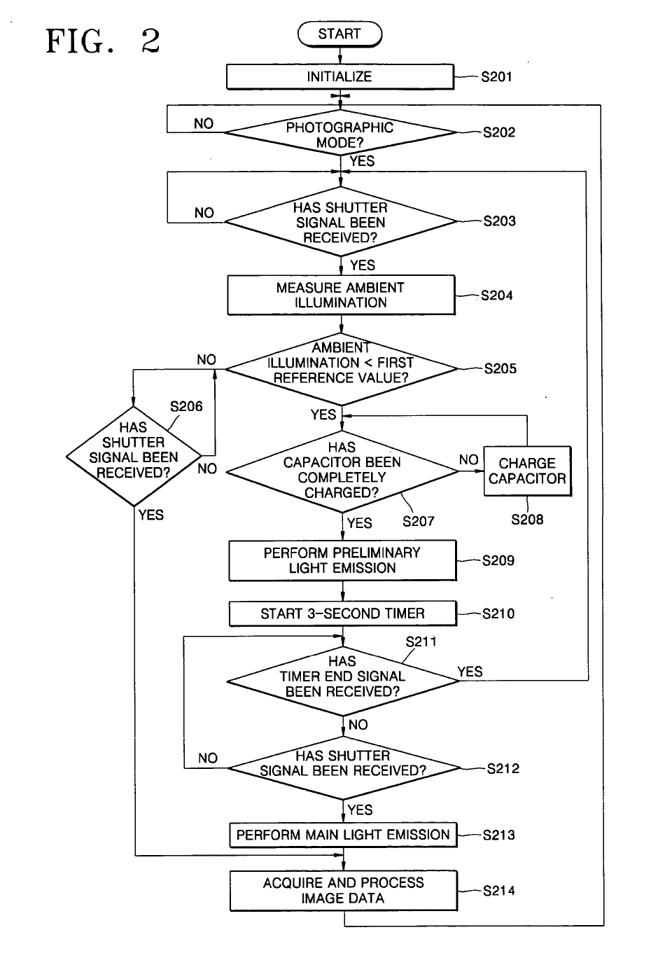

When a user presses the shutter button switch SS, a shutter signal is generated and is input to the central processing device 1. Control operations performed by the central processing device 1 in connection with the shutter signal will be described in detail later with reference to FIGS. 2 through 4. The strobe driver 5 charges the capacitor MC and drives the strobe lamp XE, for example, a xenon lamp, according to the control of the central processing device 1.

The audio output unit 6 processes a digital audio signal received via the central processing device 1 and outputs sound. The display unit 7 processes a digital display signal received via the central processing device 1 and displays the digital display signal.

Hereinafter, a photographic mode program performed by the central processing device 1 according to a first embodiment of the present invention will be described with reference to FIGS. 1 and 2.

The central processing device 1 initializes itself and other elements involved in photographic operations in step S201. When the current operation mode is determined to be a photographic mode in step S202 and when a shutter signal is received from the shutter button switches SS in step S203, ambient illumination is measured in step S204.

Next, when the measured ambient illumination is greater than or equal to a first reference value, for example, “3”, in step S205, preliminary light emission and main light emission are not performed. Subsequently, when the shutter signal is received from the shutter button switch SS in step S206, image data is acquired and processed by the photographic unit 2 in step S214. Next, the photographic mode program returns to step S202, allowing repetitive operation.

However, when the measured ambient illumination is less than the first reference value in step S205, the following steps are performed.

When the capacitor MC has not been completely charged in step S207, the capacitor MC is charged by the strobe driver 5 in step S208. Next, the strobe lamp XE is turned on by the strobe driver 5, thereby performing preliminary light emission in step S209. Next, a 3-second timer is started in step S210. Thereafter, if the shutter signal is not received from the shutter button switch SS in step S212 but a timer end signal is received in step S211, the photographic mode program returns to step S203 because the user has not completely adjusted image composition. Meanwhile, after the 3-second timer is started, if the shutter signal is received from the shutter button switch SS in step S212, the strobe lamp XE is turned on by the strobe driver 5, thereby performing main light emission in step S213, because the user has completed the adjustment of image composition. Next, image data is acquired by the photographic unit 2 in response to the main light emission in step S214. Thus, under low illumination, the user can satisfactorily adjust photographic image composition without special operations before the main light emission and image data acquisition are performed in steps S213 and S214. Next, the photographic mode program returns to step S202, allowing repetitive operation.

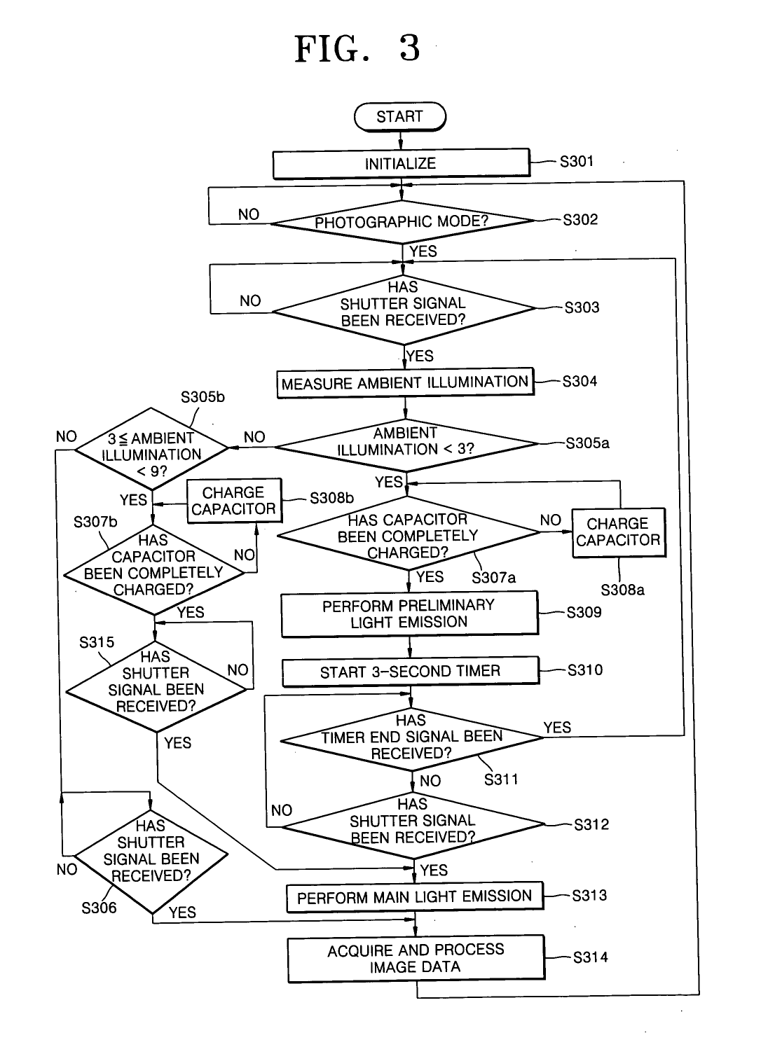

Hereinafter, a photographic mode program performed by the central processing device 1 according to a second embodiment of the present invention will be described with reference to FIGS. 1 and 3.

The central processing device 1 initializes itself and other elements involved in photographic operations in step S301. When the current operation mode is determined to be a photographic mode in step S302 and when a shutter signal is received from the shutter button switches SS in step S303, ambient illumination is measured in step S304.

Next, when the measured ambient illumination is greater than or equal to a second reference value, for example, “9”, in steps S305a and S305b, preliminary light emission and main light emission are not performed. Subsequently, when the shutter signal is received from the shutter button switch SS in step S306, image data is acquired and processed by the photographic unit 2 in step S314. Next, the photographic mode program returns to step S302, allowing repetitive operation.

However, when the measured ambient illumination is less than the second reference value and greater than or equal to a first reference value, for example, “3”, in steps S305a and S3051b, only the main light emission without the preliminary light emission is performed because the measured ambient illumination is sufficient for a user to adjust image composition although the main light emission is still required to obtain an image file. Thus, when the capacitor MC has not been completely charged in step S307b, the capacitor MC is charged by the strobe driver 5 in step S308b. Next, if the shutter signal is received from the shutter button switch in step S315, the strobe lamp XE is turned on by the strobe driver 5, thereby performing the main light emission in step S313. Next, image data is acquired by the photographic unit 2 in response to the main light emission in step S314. Next, the photographic mode program returns to step S302 for the repetitive operation.

However, when the measured ambient illumination is less than the first reference value in step S305a, the following steps are performed.

When the capacitor MC has not been completely charged in step S307a, the capacitor MC is charged by the strobe driver 5 in step S308a. Next, the strobe lamp XE is turned on by the strobe driver 5, thereby performing the preliminary light emission in step S309. Next, a 3-second timer is started in step S310. Thereafter, if the shutter signal is not received from the shutter button switch SS in step S312 but a timer end signal is received in step S311, the photographic mode program returns to step S303 because the user has not completely adjusted image composition. Meanwhile, after the 3-second timer is started, if the shutter signal is received from the shutter button switch SS in step S312, the strobe lamp XE is turned on by the strobe driver 5, thereby performing the main light emission in step S313, because the user has completed the adjustment of image composition. Next, image data is acquired by the photographic unit 2 in response to the main light emission in step S314. Accordingly, under a low illumination, the user can satisfactorily adjust photographic image composition without special operations before the main light emission and image data acquisition are performed in steps S313 and S314. Next, the photographic mode program returns to step S302 for the repetitive operation.

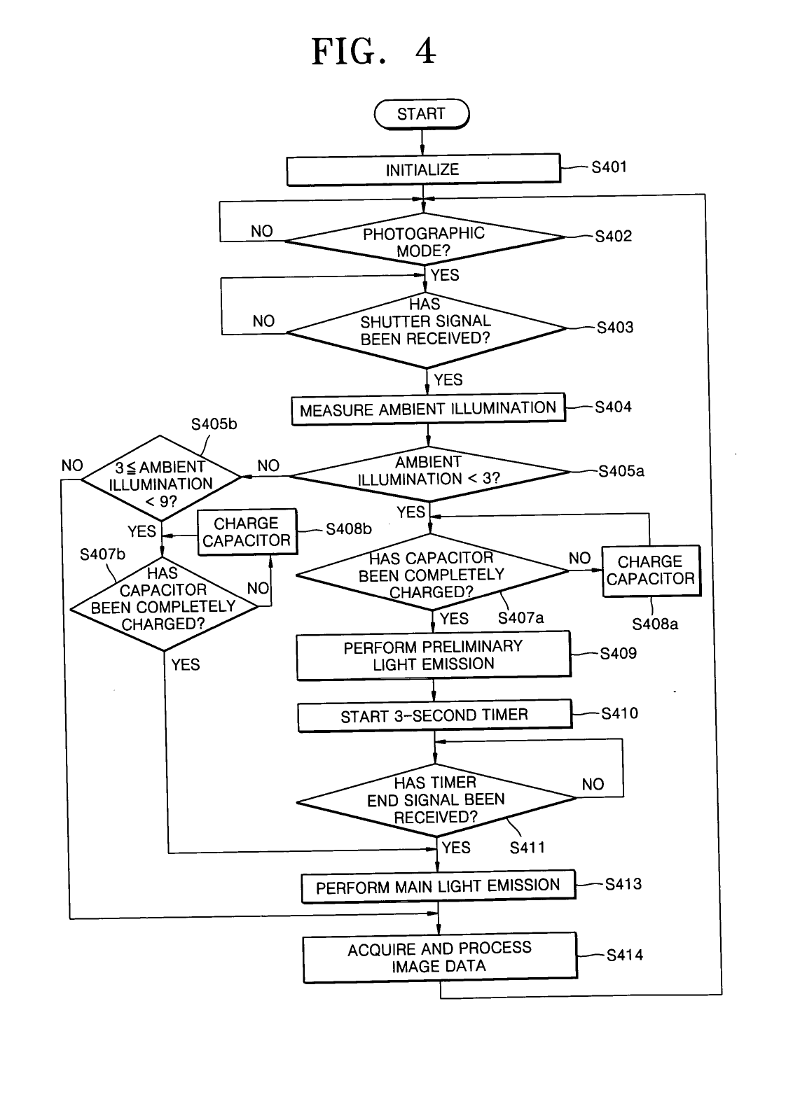

Hereinafter, a photographic mode program performed by the central processing device 1 according to a third embodiment of the present invention will be described with reference to FIGS. 1 and 4. In the third embodiment, the shutter signal is detected only once, allowing for fast and convenient operation.

The central processing device 1 initializes itself and other elements involved in photographic operations in step S401. When the current operation mode is determined to be a photographic mode in step S402 and when a shutter signal is received from the shutter button switches SS in step S403, ambient illumination is measured in step S404.

Next, when the measured ambient illumination is greater than or equal to a second reference value, for example, “9”, in steps S405a and S405b, image data is acquired and processed by the photographic unit 2 in step S414 without performing preliminary light emission and main light emission. Next, the photographic mode program returns to step S402, allowing repetitive operation.

However, when the measured ambient illumination is less than the second reference value and greater than or equal to a first reference value, for example, “3”, in steps S405a and S405b, only the main light emission without the preliminary light emission is performed because the measured ambient illumination is sufficient for a user to adjust image composition while the main light emission is still required to obtain an image file. More specifically, when the capacitor MC has not been completely charged in step S4071b, the capacitor MC is charged by the strobe driver 5 in step S408b. Next, the strobe lamp XE is turned on by the strobe driver 5, thereby performing the main light emission in step S413. Next, image data is acquired by the photographic unit 2 in response to the main light emission in step S414. Next, the photographic mode program returns to step S402, allowing repetitive operation.

However, when the measured ambient illumination is less than the first reference value in step S405a, the following steps are performed.

When the capacitor MC has not been completely charged in step S407a, the capacitor MC is charged by the strobe driver 5 in step S408a. Next, the strobe lamp XE is turned on by the strobe driver 5, thereby performing the preliminary light emission in step S409. Next, a 3-second timer is started in step S410. When a timer end signal is received after three seconds in step S411, the strobe lamp XE is turned on by the strobe driver 5, thereby performing the main light emission in step S413. Next, image data is acquired by the photographic unit 2 in response to the main light emission in step S414. Thus, under low illumination, the user can satisfactorily adjust photographic image composition, without special operations, before the main light emission and image data acquisition are performed in steps S413 and S414. Next, the photographic mode program returns to step S402, allowing repetitive operation.

Although a few embodiments of the present invention have been shown and described, it will be understood by those skilled in the art that changes may be made in these elements without departing from the spirit and scope of the invention, the scope of which is defined in the appended claims and their equivalents.

1. A method of controlling a digital camera, the method comprising:
measuring an ambient illumination;
performing preliminary light emission when the measured ambient illumination is less than a first reference value;
delaying main light emission by a predetermined time after the preliminary light emission when the measured ambient illumination is less than the first reference value;
performing the main light emission after the predetermined time has lapsed when the measured ambient illumination is less than the first reference value; and
acquiring image data during the main light emission.

2. The method of claim 1, further comprising:
processing the acquired image data.

3. The method of claim 1, wherein the step of measuring an ambient illumination occurs only if a first shutter signal has been received.

4. The method of claim 3, wherein the steps of performing the main light emission and acquiring image data are not performed unless a second shutter signal is received before the predetermined time is lapsed.

5. The method of claim 3, further comprising:
performing the main light emission after a second shutter signal has been received when the measured ambient illumination is greater than or equal to a first reference value and less than a second reference value.

6. The method of claim 5, wherein the main light emission is not performed until a related capacitor has been sufficiently charged.

7. The method of claim 3, further comprising:
acquiring image data without any light emission from the camera, after a second shutter signal has been received, when the measured ambient illumination is greater than a second reference value, wherein the second reference value is greater than the first reference value.

8. The method of claim 1, further comprising:
performing the main light emission when the measured ambient illumination is greater than or equal to a first reference value and less than a second reference value.

9. The method of claim 8, wherein the main light emission is not performed until a related capacitor has been sufficiently charged.

10. The method of claim 1, further comprising:
acquiring image data without any light emission from the camera, when the measured ambient illumination is greater than a second reference value, wherein the second reference value is greater than the first reference value.

11. The method of claim 1, wherein preliminary light emission is not performed until it is determined that a related capacitor has been sufficiently charged.

12. The method of claim 1, wherein the preliminary light emission is performed by a strobe lamp.

13. The method of claim 1, wherein the main light emission is performed by a strobe lamp.

14. A digital camera capable of adaptively emitting light, comprising:
an image photographing portion to photograph and process a digital image of an object;
a strobe lamp; and
a central processing unit capable of comparing measured ambient illumination with a first reference value, directing the camera to perform preliminary light emission when the measured ambient illumination is less than the first reference value, and directing the camera to perform main light emission after a predetermined time delay after the preliminary light emission when the measured ambient illumination is less than the first reference value.

15. The digital camera of claim 14, wherein the central processing unit is capable of comparing measured ambient illumination to a second reference value and directing the camera to perform the main light emission without preliminary light emission when the measured ambient illumination is greater than or equal to the first reference value and less than the second reference value.

16. The digital camera of claim 14, wherein the central processing unit is capable of comparing measured ambient illumination to a second reference value and directing the camera to neither perform main light emission nor preliminary light emission when the measured ambient illumination is greater than both the first reference value and the second reference value.

17. The digital camera of claim 14, further comprising a strobe driver.

18. A digital camera capable of adaptively emitting light, comprising:
an image photographing portion to photograph and process a digital image of an object;
a means for emitting light; and
a means for comparing measured ambient illumination with a first reference value;
a means for directing the camera to perform preliminary light emission when the measured ambient illumination is less than the first reference value; and
a means for directing the camera to perform main light emission after a predetermined time delay after the preliminary light emission when the measured ambient illumination is less than the first reference value.

19. The digital camera of claim 18, further comprising:
a means for comparing measured ambient illumination to a second reference value; and
a means for directing the camera to perform the main light emission without preliminary light emission when the measured ambient illumination is greater than or equal to the first reference value and less than the second reference value.

20. The digital camera of claim 18, further comprising:
a means for comparing measured ambient illumination to a second reference value; and
a means for directing the camera to neither perform main light emission nor preliminary light emission when the measured ambient illumination is greater than both the first reference value and the second reference value.
